(19) United States
(12) Patent Application Publication
(10) Pub. No.: US 2026/0130438 A1
(43) Pub. Date: May 14, 2026

(54) AEROSOL GENERATING DEVICE

(71) Applicant: KT&G CORPORATION, Daejeon (KR)

(72) Inventors: Jin Chul JUNG, Daejeon (KR); Jung Ho KIM, Seoul (KR); Sang Cheol PARK, Suwon-si (KR); Jang Won SEO, Yongin-si (KR); Won Kyeong LEE, Guri-si (KR); Chul Ho JANG, Bucheon-si (KR)

(73) Assignee: KT&G CORPORATION, Daejeon (KR)

(21) Appl. No.: 19/325,936

(22) Filed: Sep. 11, 2025

(30) Foreign Application Priority Data
Nov. 14, 2024 (KR) 10-2024-0162275
Mar. 14, 2025 (KR) 10-2025-0033598

(51) Int. Cl. A24F 40/57; A24F 40/20; A24F 40/46; A24F 40/51; A24F 40/53; A24F 40/60; H05B 3/22

(52) U.S. Cl. CPC A24F 40/57; A24F 40/20; A24F 40/46; A24F 40/51; A24F 40/53; A24F 40/60; H05B 3/22

(57) ABSTRACT

An aerosol generating device includes an insertion space into which an aerosol generating article is inserted, an electrically resistive heater arranged adjacent to the insertion space, a power supply, and a controller configured to control power supplied from the power supply to the heater, wherein the controller calculates an initial resistance value of a resistance-temperature relationship equation in a first operation mode and estimates a temperature of the heater based on the resistance-temperature relationship equation in a second operation mode.

### CROSS-REFERENCE TO RELATED APPLICATIONS

This application is based on and claims priority under 35 U.S.C. § 119 to Korean Patent Application No. 10-2024-0162275, filed on Nov. 14, 2024, and Korean Patent Application No. 10-2025-0033598, filed on Mar. 14, 2025, in the Korean Intellectual Property Office, the disclosures of which are incorporated by reference herein in their entireties.

### BACKGROUND

### 1. Field

The disclosure relates to an aerosol generating device.

### 2. Description of the Related Art

Recently, the demand for alternative methods to overcome the shortcomings of general cigarettes has increased. For example, there is a growing demand for systems in which aerosols are generated by heating cigarettes or aerosol generating materials by using aerosol generating devices, rather than methods of generating aerosols by burning cigarettes. Accordingly, research on heating-type aerosol generating devices is actively conducted.

### SUMMARY

One of key components of an aerosol generating device is a heater which heats an aerosol generating material, and precisely controlling the heater's temperature is crucial for generating an aerosol of consistent quality.

In general, resistive heaters are made of metals or metal alloys with a specific temperature coefficient of resistance (TCR), and the temperature may be calculated by using a resistance-temperature relationship equation. According to the resistance-temperature relationship equation, electrical resistance R of a resistive heater varies with a temperature T, and an initial resistance value R₀ at a reference temperature T₀ may be determined not only by a material of a heater but also by a physical shape and structure of the heater. For example, the longer the heater, the more the resistance of the heater, and accordingly, the initial resistance value R₀ increases more.

In addition, aerosol generating articles may vary in length, and manufacturers of the aerosol generating devices need to design a variety of lengths of heaters of aerosol generating devices to be optimized to each of the aerosol generating articles. Even when materials of heaters are the same, the initial resistance value R₀ changes depending on lengths of the heaters, and accordingly, manufacturers need to calculate the initial resistance value R₀ for each model of aerosol generating devices with different lengths of the heaters. Furthermore, as heaters deteriorate over time with long-term use of aerosol generating devices, the initial resistance value R₀ may change, and accordingly, the initial resistance value R₀ needs to be continuously recalculated and adjusted during the use of the aerosol generating devices.

The disclosure provides a method of resolving uncertainty in the initial resistance value R₀, which may arise during a temperature control process of a heater using a TCR in an aerosol generating device.

Additional aspects will be set forth in part in the description which follows and, in part, will be apparent from the description, or may be learned by practice of the presented embodiments of the disclosure.

According to an aspect of the disclosure, an aerosol generating device includes an insertion space into which an aerosol generating article is inserted, an electrically resistive heater arranged adjacent to the insertion space, a power supply, and a controller configured to control power supplied from the power supply to the heater, wherein the controller is further configured to calculate an initial resistance value of a resistance-temperature relationship equation in a first operation mode and estimate a temperature of the heater based on the resistance-temperature relationship equation in a second operation mode.

According to another aspect of the disclosure, an aerosol generating device includes an insertion space into which an aerosol generating article is inserted, an electrically resistive heater arranged adjacent to the insertion space, a power supply, and a controller configured to estimate a temperature of the heater based on a resistance-temperature relationship equation and control power supplied to the heater from the power supply, wherein the controller is further configured to monitor a magnitude of a current flowing through the heater, and update an initial resistance value of the resistance-temperature relationship equation when the magnitude of the current flowing through the heater deviates from a tolerance preset with respect to a magnitude of a current corresponding to the estimated temperature of the heater.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an aerosol generating device according to an embodiment;

FIG. 2 illustrates an aerosol generating device according to an embodiment;

FIG. 3 illustrates an aerosol generating device according to an embodiment;

FIG. 4 illustrates an aerosol generating device according to an embodiment;

FIG. 5 is a view illustrating a heater implemented in the form of an external heater that heats the outside of an aerosol generating article;

FIG. 6 is a view illustrating a heating sheet according to an embodiment;

FIG. 7 illustrates graphs of changes in resistance according to a change in temperature;

FIG. 8 is a flowchart illustrating a method of calculating an initial resistance value according to an embodiment;

FIG. 9 is a flowchart illustrating a method of monitoring an initial resistance value in a second operation mode, according to an embodiment; and

FIG. 10 is a flowchart illustrating a method of updating an initial resistance value in a second operation mode, according to an embodiment.

### DETAILED DESCRIPTION

Hereinafter, embodiments will be described in detail with reference to the accompanying drawings, and the same or similar components will be assigned the same reference numerals regardless of the reference numerals in the drawings, and the same descriptions thereof will be omitted. With regard to the description of the drawings, like reference numerals may be used to represent like or related elements.

The suffixes “module”, “-er”, and “-or” for the components used in the following description are given or used interchangeably by considering only the ease of writing the description, and do not have distinct meanings or roles in themselves. The suffix “module” or “unit”, as used herein, may include a unit implemented as hardware, software, or firmware. For example, the suffix “module” or “unit” may be interchangeably used with the term a “logic”, a “logical block”, a “component”, or a “circuit”. The “module” or “unit” may be an integrally formed component, a minimum unit of the component performing one or more functions, or a part of the minimum unit. For example, the “module” or “unit” may be implemented in the form of an application-specific integrated circuit (ASIC).

In addition, when describing the embodiments of the disclosure, the detailed description of the related known art, which may obscure the subject matter of the embodiments, may be omitted. Also, the accompanying drawings are only intended to facilitate understanding of the embodiments described herein, and the spirit of the disclosure is not limited by the accompanying drawings and should be understood to include all changes, equivalents or alternatives included in the spirit and scope of the disclosure.

Although the terms first, second, etc. may be used herein to describe various elements or components, these elements or components should not be limited by these terms. These terms are only used to distinguish one element or component from another element or component.

When an element is referred to as being “connected to” or “coupled to” another element, it may be directly connected or coupled to the other element or intervening elements may be present. In contrast, when an element is referred to as being “directly connected to” or “directly coupled to” another element, there are no intervening elements present.

The singular forms are intended to include the plural forms as well, unless the context clearly indicates otherwise.

Various embodiments of the present disclosure may be implemented as software including one or more instructions stored in a storage medium (e.g., a memory 17) readable by a machine (e.g., an aerosol generating device 1). For example, a processor (e.g., a controller 12) of the machine (e.g., the aerosol generating device 1) may call at least one instruction among one or more instructions stored from the storage medium and execute the at least one instruction. This makes it possible for the machine to be operated to perform at least one function according to the called at least one instruction. Examples of the one or more instructions may include codes created by a compiler, or codes executable by an interpreter. A machine-readable storage medium may be provided as a non-transitory storage medium. The ‘non-transitory storage medium’ is a tangible device and only means that it does not contain a signal (e.g., electromagnetic waves). This term does not distinguish a case in which data is stored semi-permanently in a storage medium from a case in which data is temporarily stored.

In the present disclosure, a direction of the aerosol generating device 1 may be defined based on an orthogonal coordinate system. The x-axis direction in the orthogonal coordinate system may be defined as a left-right direction of the aerosol generating device 1. The y-axis direction may be defined as a front-back direction of the aerosol generating device 1. The z-axis direction may be defined as an upward and downward direction of the aerosol generating device 1.

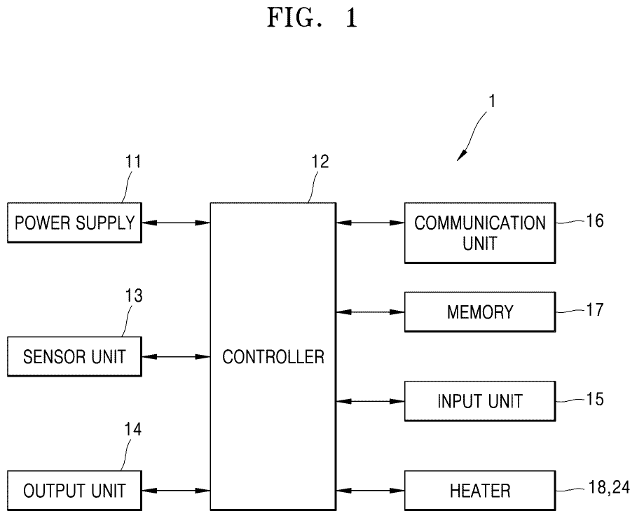

FIG. 1 is a block diagram of the aerosol generating device 1 according to an embodiment.

According to an embodiment, the aerosol generating device 1 may include a power supply 11, the controller 12, a sensor unit 13, an output unit 14, an input unit 15, a communication unit 16, a memory 17, and/or heater 18 or 24. However, it may be understood by those skilled in the art that some of the components shown in FIG. 1 may be omitted or new components may be added, according to the design of the aerosol generating device 1.

According to an embodiment, the sensor unit 13 may sense a state of the aerosol generating device 1 or a state of the surroundings of the aerosol generating device 1 and may transmit information corresponding to the sensed state to the controller 12. For example, the sensor unit 13 may include a temperature sensor, a puff sensor, an insertion detection sensor, a reuse detection sensor, an overwetting detection sensor, a cigarette identification sensor, a cartridge detection sensor, a cap detection sensor, and/or a movement detection sensor. The sensor unit 13 may further include various sensors, such as a liquid remaining amount sensor for detecting the liquid remaining amount of a cartridge and an immersion sensor for detecting immersion of the aerosol generating device 1.

According to an embodiment, the temperature sensor may detect the heating temperature of the heater 18 or 24. The aerosol generating device 1 may include a separate temperature sensor for detecting respective temperatures of the heater 18 or 24, or the heater 18 or 24 may serve as a temperature sensor. For example, the temperature sensor may be used to measure an impedance of the heater 18. The impedance of the heater 18 may be correlated with the temperature of the heater 18. The temperature sensor may measure a current and/or voltage applied to the heater 18 (or an induction coil). Based on the measured current and/or voltage, the impedance for the heater 18 may be calculated. The controller 12 may estimate the temperature of the heater 18, based on the calculated impedance.

For example, the temperature sensor may include a resistive element (e.g., a thermistor) whose resistance value changes in response to a change in temperatures of the heater 18 or 24. The temperature sensor may output a signal corresponding to the resistance value of the resistive element, and the controller 12 may detect the temperatures and/or temperature changes of the heater 18 or 24, based on the signal corresponding to the resistance value.

As another example, the temperature sensor may include a sensor for detecting the resistance values of the heater 18 or 24. The temperature sensor may output signals corresponding to the resistance values of the heater 18 or 24, and the controller 12 may detect the temperatures and/or temperature changes of the heater 18 or 24, based on the signals corresponding to the resistance values.

According to an embodiment, the temperature sensor may detect a temperature of the power supply 11. The temperature sensor may be disposed adjacent to the power supply 11. For example, the temperature sensor may be attached to one surface of the power supply 11 (e.g., a battery) and/or mounted on one surface of a printed circuit board. For example, the aerosol generating device 1 may include a power protection circuit module (PCM), and the temperature sensor may be disposed adjacent to the power supply 11 together with the power PCM.

According to an embodiment, the temperature sensor may be disposed inside a housing (not shown) of the aerosol generating device 1 to detect an internal temperature of the housing.

According to an embodiment, the puff sensor may detect a puff of a user.

For example, the puff sensor may include a pressure sensor. The pressure sensor may output a signal corresponding to an internal pressure of the aerosol generating device 1, and the controller 12 may detect the puff of the user, based on the signal corresponding to the internal pressure. The internal pressure of the aerosol generating device 1 may correspond to pressure of an airflow path along which gas flows. The puff sensor may be disposed to correspond to the airflow path along which gas flows, in the aerosol generating device 1.

As another example, the puff sensor may include a temperature sensor. When the user' puff occurs, a temporary temperature drop may occur in the airflow path, a space where an aerosol generating article is inserted (hereinafter, an insertion space), the heater 18 or 24, etc. The controller 12 may detect the user's puff, based on a signal corresponding to the temperature of the airflow path, etc. output from the temperature sensor.

As another example, the puff sensor may include both a pressure sensor and a temperature sensor. In this case, the temperature sensor may measure a temperature that is used to correct an internal pressure measured by the pressure sensor. For example, the puff sensor may correct the signal corresponding to the internal pressure, based on the temperature measured by the temperature sensor, and may output the corrected signal. As another example, the puff sensor may output the signal corresponding to the temperature measured by the temperature sensor, and the signal corresponding to the internal pressure measured by the puff sensor. In this case, the controller 12 may receive the signals, and may correct the signal corresponding to the internal pressure, based on the signal corresponding to the temperature.

As another example, the puff sensor may include a capacitance sensor. In the present disclosure, the capacitance sensor may also be referred to as a cap sensor or a capacitive sensor. When the user's puff occurs, a temperature change and/or aerosol flow may occur within the insertion space of the aerosol generating article, and accordingly, an internal permittivity of the insertion space may change. The controller 12 may detect the user's puff, based on a signal corresponding to the internal permittivity, etc. of the insertion space output by the temperature sensor.

The puff sensor is not limited to the aforementioned examples, and may be implemented using various sensors for detecting the user's puff.

According to an embodiment, the insertion detection sensor may detect insertion and/or removal of the aerosol generating article. The insertion detection sensor may be provided around the insertion space. The insertion detection sensor may also include any combination of the aforementioned examples.

For example, the insertion detection sensor may include a capacitance sensor. The capacitance sensor may include at least one conductor. The at least one conductor may be arranged adjacent to the insertion space. When the aerosol generating article is inserted into or removed from the insertion space, a permittivity around the conductor may change. The controller 12 may detect the insertion and/or removal of the aerosol generating article, based on a signal corresponding to the internal permittivity, etc. of the insertion space output by the capacitance sensor.

As another example, the insertion detection sensor may include an inductive sensor. The inductive sensor may include at least one coil. The at least one coil may be disposed adjacent to the insertion space. When the aerosol generating article (e.g., a wrapper of the aerosol-generating article) includes a conductor and is inserted into or removed from the insertion space, a change in a magnetic field may occur around a coil where a current flows. The controller 12 may detect insertion and/or removal of the aerosol generating article including the conductor, based on the characteristics (e.g., a frequency, a current value, a voltage value, an inductance value, and an impedance value of an alternating current) of a current output or detected by the inductive sensor. Alternatively, the aerosol generating article (e.g., a medium portion of the aerosol generating article) may include a susceptor (SUS), etc. Even in this case, a change in the magnetic field around the coil may occur based on the insertion or removal of the susceptor, etc. within the insertion space, and the controller 12 may also detect the insertion and/or removal of the aerosol generating article, based on the characteristics of the current of the inductive sensor.

The insertion detection sensor is not limited to the aforementioned examples, and may be implemented using any of various sensors (e.g., a proximity sensor) for detecting insertion and/or removal of the aerosol generating article. The insertion detection sensor may also include any combination of the aforementioned examples. According to an embodiment, the insertion detection sensor may include a switch, etc. for detecting compression performed by the aerosol generating article.

According to an embodiment, the reuse detection sensor may detect whether the aerosol generating article is reused. For example, the reuse detection sensor may be a color sensor for detecting a color of the aerosol generating article. When the aerosol generating article is used by the user, a change in the color of a portion of the wrapper surrounding the outside of the aerosol generating article may occur due to generated aerosol or heating. The color sensor may output a signal corresponding to optical characteristics (e.g., a wavelength of light) corresponding to the color of the wrapper, based on light reflected by the wrapper. When a change in the color of the portion of the wrapper is detected, the controller 12 may determine that the aerosol generating article inserted into the insertion space has already been used.

According to an embodiment, the overwetting detection sensor may detect whether the aerosol generating article is in an overwetting state. For example, the overwetting detection sensor may include a capacitance sensor. The capacitance sensor may include at least one conductor disposed adjacent to the insertion space. The controller 12 may detect whether the aerosol generating article is in an overwetting state, based on the level of a signal corresponding to a permittivity, etc. output by the capacitance sensor. For example, the controller 12 may check a level range including the level of the signal, based on a look-up table, and may determine a moisture content for the aerosol generating article, based on the checked level range.

According to an embodiment, the cigarette identification sensor may detect whether the aerosol generating article is authentic, and/or detect the type of the aerosol generating article.

For example, the cigarette identification sensor may include an optical sensor for detecting an identification material (or an identification mark) located on an outer surface (e.g., a wrapper) of the aerosol generating article. The optical sensor may radiate light toward the identification material (or the identification mark) of the aerosol generating article, and may detect the authenticity and/or the type of the aerosol generating article, based on the reflected light. For example, the identification material may include a material that emits light of a wavelength in a specific band, based on the radiated light. The controller 12 may detect the authenticity and/or the type of the aerosol generating article, based on the range of the wavelength.

As another example, the cigarette identification sensor may include a capacitance sensor. According to the types of aerosol generating article inserted into the insertion space, the internal permittivity of the insertion space may vary. The controller 12 may detect he authenticity of and/or the type of the aerosol generating article, based on the signal corresponding to the internal permittivity, etc. of the insertion space output by the capacitance sensor.

As another example, the cigarette identification sensor may include an inductive sensor. When a conductor is included in the wrapper and/or interior (e.g., a medium portion) of the aerosol generating article inserted into the insertion space, the characteristics of a current detected by the inductive sensor (e.g., a frequency, a current value, a voltage value, an inductance value, and an impedance value of an AC current) may differ according to the types of aerosol generating article inserted into the insertion space. The controller 12 may detect he authenticity of and/or the type of the aerosol generating article, based on the characteristics of a current output by the capacitance sensor or detected by the inductive sensor.

The cigarette identification sensor is not limited to the aforementioned examples, and may be implemented using any of various sensors for detecting whether the aerosol generating article is authentic, and/or detecting the type of the aerosol generating article.

The cigarette identification sensor may also include any combination of the aforementioned examples.

According to an embodiment, the cartridge detection sensor may detect insertion and/or removal of the cartridge. For example, the cartridge detection sensor may include an inductive sensor, a capacitance sensor, a resistance sensor, a hall sensor (a hall IC) using a hall effect, and/or an optical sensor.

According to an embodiment, the cap detection sensor may detect insertion and/or removal of the cap. For example, the cap detection sensor may include an inductive sensor, a capacitance sensor, a resistance sensor, a hall sensor (a hall IC), and/or an optical sensor. The cap may include a structure that covers at least a portion of the cartridge mounted on or inserted into the aerosol generating device 1 or covers at least a portion of the housing of the aerosol generating device 1. When the cap is mounted on or removed from the housing, the cap detection sensor may output a signal corresponding to the mounting or removal of the cap. The controller 12 may detect the mounting or removal of the cap, based on a signal corresponding to the mounting or removal.

According to an embodiment, the movement detection sensor may detect a motion of the aerosol generating device 1. The movement detection sensor may be implemented using at least one of an acceleration sensor and a gyro sensor.

According to an embodiment, the sensor unit 13 may further include at least one of a humidity sensor, a pressure sensor, a magnetic sensor, a global positioning sensor (GPS), or a proximity sensor, in addition to the above-described sensors. Functions of the sensors would be instinctively understood by one of ordinary skill in the art in view of their names and thus detailed descriptions thereof will be omitted herein.

According to an embodiment, the output unit 14 may output information about the state of the aerosol generating device 1. The output unit 14 may include a display, a haptic unit, and/or a sound output unit, but embodiments are not limited thereto. For example, information about the aerosol generating device 1 may include a charging/discharging state of the power supply 11 of the aerosol generating device 1, preheating states of the heater 18 or 24, an insertion/removal state of the aerosol generating article and/or the cartridge, a mounting and/or removal state of the cap, or a state in which use of the aerosol generating device 1 is limited (e.g., detection of an abnormal article). The display may visually provide the information about the state of the aerosol generating device 1 to the user. For example, the display may include a light-emitting diode (LED), a liquid crystal display (LCD), an organic light-emitting diode (OLED), etc. When the display includes a touch pad, the display may also be used as an input unit 15. A haptic unit may tactually provide the information about the state of the aerosol generating device 1 to the user. For example, the haptic unit may include a vibration motor, a piezoelectric element, an electrical stimulation device, etc. The sound output unit may acoustically provide the information about the aerosol generating device 1 to the user. For example, the sound output unit may convert an electrical signal into a sound signal and may output the sound signal to the outside.

According to an embodiment, the power supply 11 may output power for operating the aerosol generating device 1. The power supply 11 may include one or more batteries. The power supply 11 may supply power so that the heater 18 or 24 may be heated. In addition, the power supply 11 may supply power required for operations of the controller 12, the sensor unit 13, the output unit 14, the input unit 15, the communication unit 16, the memory 17, etc. which are other components included in the aerosol generating device 1. The power supply 11 may be a rechargeable battery or a disposable battery. For example, the power supply 11 may be a lithium polymer (LiPoly) battery, but embodiments are not limited thereto. The power supply 11 may be a rechargeable (separate-type) battery (hereinafter, a detachable battery. The detachable battery may be mounted on a battery accommodation part provided within the aerosol generating device 1, or may be removed from the battery accommodation part. The detachable battery may be charged either via wire or wirelessly.

According to an embodiment, the heater 18 or 24 may heat a medium and/or an aerosol generating material within the aerosol generating article and/or the cartridge by receiving power from the power supply 11. The aerosol generating device 1 may include a heater 18 for heating the aerosol generating article and/or a cartridge heater 24 for heating the cartridge (i.e., a solid and/or liquid medium).

According to an embodiment, the heater 18 or 24 may be electro-resistive heaters. For example, the electro-resistive heaters may include an electro-resistive material, such as a metal including titanium, zirconium, tantalum, platinum, nickel, cobalt, chromium, hafnium, niobium, molybdenum, tungsten, tin, gallium, manganese, iron, copper, stainless steel, nichrome, or the like, or a metal alloy. The electro-resistive heaters may be implemented using a metal heating wire, a metal heating plate on which an electric conductive track is disposed, a ceramic heating body, or the like.

According to an embodiment, the heater 18 or 24 may be induction heating heaters. For example, the induction heating heaters may include a susceptor that generates heat through a magnetic field. The magnetic field may be generated from an induction coil by an AC current flowing through the induction coil. The generated magnetic field may penetrate a heater and an eddy current may be generated by the susceptor. The susceptor may be heated based on the generation of the eddy current. According to an embodiment, the susceptor may be included within the aerosol generating article (e.g., the medium portion). Even in this case, the susceptor included within the aerosol generating article may be heated by the induction coil.

The heater 18 or 24 are not limited to the aforementioned examples, and may include or be replaced with various heating methods, structures, components, etc. for heating the aerosol generating article and/or the cartridge.

According to an embodiment, the input unit 15 may receive information input by the user. For example, the input unit 15 may include a touch panel, a button, a keypad, a dome switch, a jog wheel, a jog switch, etc.

According to an embodiment, the memory 17 is hardware for storing various kinds of data processed in the aerosol generating device 1, and may store pieces of data that have been processed and are to be processed by the controller 12. For example, the memory 17 may include at least one type of storage medium selected from among a flash memory type, a hard disk type, a multimedia card micro type, a card type memory (for example, a secure digital (SD) or extreme digital (XD) memory), a random access memory (RAM), a static random access memory (SRAM), a read-only memory (ROM), an electrically erasable programmable ROM (EEPROM), a programmable ROM (PROM), magnetic memory, a magnetic disk, and an optical disk. For example, the memory 17 may store data about an operating time of the aerosol generating device 1, a maximum number of puffs, a current number of puffs, at least one temperature profile, and the user's smoking pattern.

According to an embodiment, the communication unit 16 may include at least one component for communication with another electronic device (e.g., a portable electronic apparatus). For example, the communication unit 16 may include a Bluetooth communication unit, a Bluetooth Low Energy (BLE) communication unit, an Near Field Communication (NFC) communication unit, a wireless local area network (WLAN) communication unit, a ZigBee communication unit, an infrared Data Association (IrDA) communication unit, a Wireless Fidelity Direct (WFD) communication unit, an ultra wideband (UWB) communication unit, an Adaptive Network Topology (Ant)+ communication unit, a cellular network communication unit, an Internet communication unit, a computer network (e.g., a LAN or WAN) communication unit, etc.

According to an embodiment, the controller 12 may control overall operations of the aerosol generating device 1. For example, the controller 12 may include at least one processor. The controller 12 may be implemented as an array of a plurality of logic gates, or as a combination of a general-use micro controller unit (MCU) (or a microprocessor) and a memory in which a program executable by the general-use MCU is stored. It will also be understood by one of ordinary skill in the art to which the present embodiment pertains that the controller 12 may be implemented as other types of hardware.

According to an embodiment, the controller 12 may control supplying of the power of the power supply 11 to the heater 18 or 24, thereby controlling the temperatures of the heater 18 or 24. The controller 12 may control the temperatures of the heater 18 or 24 and/or power supplied to the heater 18 or 24, based on the temperatures of the heater 18 or 24 detected using the temperature sensor (e.g., the sensor unit 13). The controller 12 may control the temperatures of the heater 18 or 24 and/or the power supplied to the heater 18 or 24, based on a temperature profile and/or a power profile stored in the memory 17.

According to an embodiment, the controller 12 may control power (e.g., a voltage and/or a current) supplied to the heater 18 or 24 by controlling a power conversion circuit (not shown) electrically connected to the heater 18 or 24 and the power supply 11. For example, the power conversion circuit may include a DC/DC converter (e.g., a buck converter, a buck-boost converter, a boost converter, or a Zener diode) that converts power that is to be supplied to the heater 18 or 24, and a DC/AC converter (e.g., an inverter) that converts power that is to be supplied to an induction coil (not shown). The DC/AC inverter may be implemented as a full-bridge circuit or half-bridge circuit including a plurality of switching elements. For example, the power conversion circuit may include at least one switching element, such as a bipolar junction transistor (BJT) and a field effect transistor (FET).

According to an embodiment, the controller 12 may control the current and/or voltage supplied to the heater 18 or 24 by controlling the frequency and/or duty ratio of a current pulse input to the at least one switching element of the power conversion circuit. A duty ratio with respect to an on/off operation of the switching element may correspond to a ratio of an output voltage of the power conversion circuit to an output voltage of the power supply 11.

According to an embodiment, the controller 12 may control power that is supplied to the heater 18 or 24, by using at least one method among a pulse width modulation (PWM) method and a proportional-integral-differential (PID) method. For example, the controller 12 may control a current pulse having a certain frequency and a duty ratio to be supplied to the heater 18 or 24, by using the PWM method. The controller 12 may control the power supplied to the heater 18 or 24, by adjusting the frequency and duty ratio of the current pulse. For example, the controller 12 may determine a target temperature that is a target of control, based on the temperature profile. The controller 12 may control the power supplied to the heater 18 or 24, by using a PID method, which is a feedback control method using a difference value between the temperatures of the heater 18 or 24 and the target temperature thereof, a value obtained by integrating the difference value according to the flow of time, and a value obtained by differentiating the difference value according to the flow of time.

According to an embodiment, the controller 12 may determine target power that is a target of control, based on the power profile. The controller 12 may control the power supplied to the heater 18 or 24 to correspond to preset target power, according to the flow of time.

According to an embodiment, the controller 12 may detect the user's puff by detecting the power supplied to the heater 18 or 24. In more detail, the controller 12 may control the power supplied to the heater 18 or 24, by using the PID method. When the user' puff occurs, a temporary temperature drop may occur in a space where the aerosol generating article is inserted (hereinafter, the insertion space), the heater 18 or 24, etc. Accordingly, a change may occur in the power (or current) supplied to the heater 18 or 24 during power control using the PID method. The controller 12 may detect the user's puff, based on a change in the power that is controlled.

According to an embodiment, the controller 12 may prevent the heater 18 or 24 from being heated. For example, the controller 12 may control an operation of the power conversion circuit so that the amount of the power supplied to the heater 18 or 24 is reduced or the power supply to the heater 18 or 24 is stopped, based on the temperatures of the heater 18 or 24 exceeding a preset limit temperature.

According to an embodiment, the controller 12 may control charging/discharging of the power supply 11. For example, the controller 12 may check the temperature of the power supply 11 by using the temperature sensor (e.g., the sensor unit 13). When the temperature of the power supply 11 is equal to or greater than a first limit temperature, the controller 12 may block charging of the power supply 11. When the temperature of the power supply 11 is greater than or equal to a second limit temperature, the controller 12 may stop using (e.g., discharging) the power stored in the power supply 11. The controller 12 may calculate the remaining capacity of the power stored in the power supply 11. For example, the controller 12 may calculate the remaining capacity of the power supply 11, based on a voltage and/or current sensing value of the power supply 11.

According to an embodiment, the controller 12 may control supply of power to the heater 18 or 24, based on a result of the sensing performed by the sensor 13.

According to an embodiment, the controller 12 may control supply of power to the heater 18 or 24, based on insertion and/or removal of the aerosol generating article into and/or the insertion space. For example, when it is determined using the insertion detection sensor (e.g., the sensor unit 13) that the aerosol generating article has been inserted into the insertion space, the controller 12 may control power to be supplied to the heater 18 or 24. When it is determined using the insertion detection sensor (e.g., the sensor unit 13) that the aerosol generating article has been removed from the insertion space, the controller 12 may block the supply of power to the heater 18 or 24. When the temperatures of the heater 18 or 24 are equal to or greater than a limit temperature or temperature change slopes of the heater 18 or 24 are equal to or greater than a set slope, the controller 12 may determine that the aerosol generating article has been removed from the insertion space.

According to an embodiment, the controller 12 may control power supply time periods and/or power supply amounts for the heater 18 or 24, based on the state of the aerosol generating article. For example, when it is determined using the overwetting detection sensor (e.g., the sensor unit 13) that the aerosol generating article is in an overwetting state, the controller 12 may increase the power supply time periods (e.g., preheating time periods) for the heater 18 or 24.

According to an embodiment, the controller 12 may control supply of power to the heater 18 or 24, based on reuse or non-reuse of the aerosol generating article. For example, when it is determined that the aerosol generating article has been used, the controller 12 may block supply of power to the heater 18 or 24.

According to an embodiment, the controller 12 may control supply of power to the heater 18 or 24, based on attachment and/or removal of the cartridge. For example, when it is determined using the cartridge detection sensor (e.g., the sensor unit 13) that the cartridge is in a separated state, the controller 12 may block supply of power to the heater 18 or 24 or may control power to be not supplied to the heater 18 or 24.

According to an embodiment, the controller 12 may control supply of power to the heater 18 or 24, based on whether the aerosol generating material of the cartridge has been exhausted. For example, when it is determined that the temperatures of the heater 18 or 24 exceed the limit temperature while the heater 18 or 24 are being preheated (i.e., in a preheating section), the controller 12 may determine that the aerosol generating material in the cartridge has been exhausted. When it is determined that the aerosol generating material of the cartridge has been exhausted, the controller 12 may cut off the supply of power to the heater 18 or 24.

According to an embodiment, the controller 12 may control the supply of power to the heater 18 or 24, based on whether use of the cartridge is possible. For example, when it is determined based on data stored in the memory 17 that a current number of puffs is equal to or greater than a maximum number of puffs set in the cartridge, the controller 12 may determine that the use of the cartridge is not possible. For example, when a total time period during which the heater 18 or 24 are heated is greater than or equal to a preset maximum time period or a total amount of power supplied to the heater 18 or 24 is greater than or equal to a preset maximum power amount, the controller 12 may determine that the use of the cartridge is not possible. In this case, the controller 12 may block supply of power to the heater 18 or 24 or may control power to be not supplied to the heater 18 or 24.

According to an embodiment, the controller 12 may control the supply of power to the heater 18 or 24, based on the user's puff. For example, the controller 12 may determine occurrence or non-occurrence of a puff and/or the intensity of the puff, by using the puff sensor (e.g., the sensor unit 13). When the number of puffs reaches the preset maximum of puffs or puffs are not sensed for a preset time period or more, the controller 12 may cut off the supply of power to the heater 18 or 24. When a puff is sensed, the controller 12 may control the supply of power to the heater 18 or 24.

According to an embodiment, the controller 12 may control supply of power to the heater 18 or 24, based on authenticity of the aerosol generating article (or the cartridge) and/or the type of the aerosol generating article. For example, the controller 12 may detect authenticity or of the aerosol generating article and/or the type of the aerosol generating article, by using the cigarette identification sensor (e.g., the sensor unit 13). For example, when the aerosol generating article (or the cartridge) is detected as counterfeit, the controller 12 may block supply of power to the heater 18 or 24. When the aerosol generating article (or the cartridge) is detected as authentic, the controller 12 may control (e.g., start) supply of power to the heater 18 or 24. As another example, the controller 12 may differently control power supply to the heater 18 or 24 according to the types of aerosol generating article (or cartridge). In more detail, when the aerosol generating article (or the cartridge) is detected as a first aerosol generating article (or a first cartridge), the controller 12 may control the temperatures and/or power of the heater 18 or 24, based on a first temperature profile (or a first power profile), and, when the aerosol generating article (or cartridge) is detected as a second aerosol generating article (or a second cartridge), may control the temperatures and/or power of the heater 18 or 24, based on a second temperature profile (or a second power profile).

According to an embodiment, the controller 12 may control the output unit 14, based on a result of the sensing performed by the sensor unit 13. For example, when the number of puffs counted using the puff sensor (e.g., the sensor unit 13) reaches a preset number, the controller 12 may control the output unit 14 to visually, tactually, and/or acoustically provide information indicating that the aerosol generating device 1 is about to be terminated. For example, the controller 12 may control the output unit 14 to visually, tactually, and/or acoustically provide information about the temperatures of the heater 18 or 24.

According to an embodiment, the controller 12 may store and update a history of an event occurred in the memory 17, based on certain event occurrence. For example, the event may include insertion detection of the aerosol generating article, heating start of the aerosol generating article, puff detection, puff end, overheat detection of the heater 18 or 24, detection of overvoltage application to the heater 18 or 24, heating end of the aerosol generating article, an operation such as power on/off of the aerosol generation device 1, charging start of the power supply 11, detection of overcharging of the power supply 11, and charging end of the power supply 11, which are performed by the aerosol generating device 1. For example, the history of the event may include, for example, a date and time of the event, and log data corresponding to the event. For example, when a predetermined event is insertion detection of the aerosol generating article, log data corresponding to the event may include data for a sensing value, etc. of the insertion detection sensor (e.g., the sensor unit 13). For example, when the predetermined event is overheating detection of the heater 18 or 24, the log data corresponding to the event may include data about, for example, the temperature of the heater 18 or 24, the voltage applied to the heater 18 or 24, and the current flowing through the heater 18 or 24.

According to an embodiment, the controller 12 may control the communication unit 16 to form a communication link with an external device, such as the user's mobile terminal.

According to an embodiment, when receiving data on authentication from the external device through the communication link, the controller 12 may dismiss limitation of the use of at least one function (e.g., a heating function) of the aerosol generating device 1. For example, the data on authentication may include the user's birthday, a unique number representing the user, and completion or non-completion of authentication of the user.

According to an embodiment, the controller 12 may transmit data on the state of the aerosol generating device 1 (e.g., a remaining capacity of the power supply 11, and an operating mode) to the external device via the communication link. The transmitted data may be output through, for example, a display of the external device.

According to an embodiment, when a request for a location search of the aerosol generating device 1 is received from the external device via the communication link, the controller 12 may control the communication unit 16 to perform an operation corresponding to the location search. For example, the controller 12 may control the haptic unit to generate vibration, or may control the display to output an object corresponding to the location search and a search end.

According to an embodiment, when receiving firmware data from the external device via the communication link, the controller 12 may perform firmware update.

According to an embodiment, the controller 12 may transmit data on a sensing value of at least one sensor unit 13 to an external server (not shown) through the communication link, and may receive and store a learning model generated by learning sensing values from a server through machine learning, such as deep learning. The controller 12 may perform, for example, an operation of determining the user's inhaling pattern and an operation of generating a temperature profile, by using the learning model received from the server.

Although not shown in FIG. 1, the aerosol generating device 1 may further include a power supply protection circuit. The power protection circuit may include at least one switching element, and may cut off transmission path to the power supply 11 in response to overcharging and/or overdischarging of the power supply 11. The aerosol generating device 1 may further include a connection interface, such as a universal serial bus (USB) interface, and may transmit/receive information by being connected to another external device through the connection interface, or may charge the power supply 11.

The aerosol generating article as described herein may include at least one aerosol generating rod (e.g., a medium portion) and at least one filter rod. The heater 18 may be arranged to correspond to the at least one aerosol generating rod, and may be designed differently according to arrangement orders and/or locations of the aerosol generating rod and the filter rod. The aerosol generating rod may include at least one of nicotine, an aerosol generating material, and additives. For example, the aerosol generating material may include glycerin (e.g., vegetable glycerin (VG)) and/or propylene glycol (PG), but may also include various other materials. For example, the additives may include flavors and/or organic acid, and may also include various other materials. For example, the aerosol generating rod may include an aerosol generating substrate (e.g., a sheet) impregnated with a liquid non-tobacco material (e.g., an aerosol generating material and/or nicotine), and/or may include a solid tobacco material (e.g., leaf tobacco and reconstituted tobacco). The tobacco material may be included in the aerosol generating rod in various forms, such as Cut Tobacco, granules, or powder. According to an embodiment, the additives of the aerosol generating rod may include an alkaline substance. Based on the basic material, the nicotine of the tobacco material included in the aerosol generating rod may have an alkaline pH (e.g., pH 7.0 or higher). In this case, freebase nicotine may be released from the aerosol generating rod even at low temperature. According to an embodiment, the aerosol generating rod may include two or more aerosol generating rods, wherein the two or more aerosol generating rods may include a tobacco material and/or a non-tobacco material, respectively. Although not shown, at least one aerosol generating rod and at least one filter rod may be individually and/or integrally wrapped by at least one wrapper. In the disclosure, the aerosol generating article may be referred to as a stick.

The cartridge mentioned in the disclosure may contain an aerosol generating material in any one state among a liquid state, a solid state, a gaseous state, a gel state, and the like. The aerosol generating material may include a liquid composition. For example, the liquid composition may be a liquid including a tobacco-containing material having a volatile tobacco flavor component, or may be a liquid including a non-tobacco material. The cartridge may include a storage containing an aerosol generating material and/or a liquid delivery unit impregnated with (containing) the aerosol-generating material. For example, the liquid delivery unit may include a wick or the like, such as a cotton fiber, a ceramic fiber, a glass fiber, or porous ceramic. The cartridge heater 24 may be included in the cartridge, as a coil-shaped structure that is wound around the liquid delivery unit or in a structure in contact with one side of the liquid delivery unit. Alternatively, the cartridge heater 24 may be included in an aerosol generating device 1 that is separable from the cartridge.

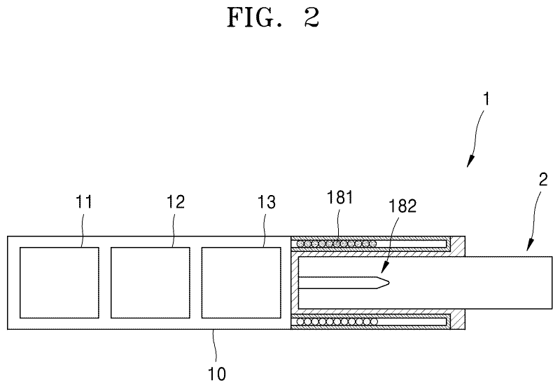

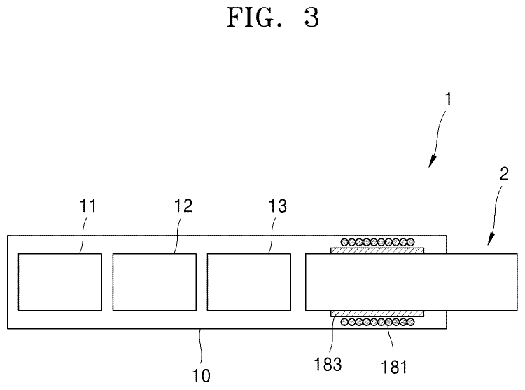

FIG. 2 illustrates an aerosol generating device according to an embodiment. FIG. 3 illustrates an aerosol generating device according to an embodiment.

According to an embodiment, the aerosol generating device 1 may include a housing 10, the power supply 11, the controller 12, the sensor unit 13, and/or a heater 182 or 183 (e.g., the heater 18 of FIG. 1). However, the components included in the aerosol generating device 1 are not limited to those shown in FIG. 2 or 3. It may be understood by those skilled in the art that some of the components shown in FIG. 2 or 3 may be omitted or new components may be added. The aerosol generating device 1 illustrated in FIG. 2 may be referred to as an ‘internal heating type’ aerosol generating device that heats the inside of an aerosol generating article 2. The aerosol generating device 1 illustrated in FIG. 3 may be referred to as an ‘external heating type’ aerosol generating device that heats the outside of the aerosol generating article 2. In the drawings below, any description that overlaps with FIG. 1 will be omitted.

According to an embodiment, the housing 10 may provide a space opened upward so that the aerosol generating article 2 may be inserted. In the disclosure, the upwardly-opened space may be referred to as an insertion space. The insertion space may be recessed toward the inside of the body 10 by a certain depth so that at least a portion of the aerosol generating article 2 may be inserted thereinto. The depth of the insertion space may be equal to or greater than a length of a region in the aerosol generating article 2, in which an aerosol generating material and/or a medium is included. A lower end of the aerosol generating article 2 may be inserted into the housing 10, and an upper end of the aerosol generating article 2 may protrude to the outside of the housing 10. A user may inhale aerosol by holding, in his or her mouth, the upper end of the aerosol generating article 2 exposed to the outside.

According to an embodiment, the heaters 182 and 183 may heat the aerosol generating article 2.

Referring to FIG. 2, the heater 182 may be implemented as an internal heating heater.

According to an embodiment, the internal heating heater may extend long upward in a space (i.e., the insertion space) into which the aerosol generating article 2 is inserted. As illustrated in FIG. 2, the internal heating heater may include a rod-shaped heating element or a needle-shaped heating element. However, the internal heating heater may include any of various heating elements, such as a tube-shaped heating element or a plate-shaped heating element. The internal heating heater may be inserted through a lower side of the aerosol generating article 2.

According to an embodiment, the internal heating heater may include an electrically resistive heater and/or an induction heating heater.

For example, the electrically resistive heater may include an electrically resistive material on the inside (e.g., an inner hollow or an inner surface) or the outside (e.g., an outer surface), and may be heated as a current flows through the electrically resistive material. In this case, the electrically resistive heater may be electrically connected to the power supply 11, and may directly generate heat by receiving a current from the power supply 11. An induction coil 181 may be omitted.

For example, in the case of induction heating heaters, the aerosol generating device 1 may include the induction coil 181 surrounding at least a portion of the internal heating heater (e.g., being positioned outside to correspond to a length of at least a portion of the heater). In this case, a magnetic flux concentrator, etc. may be further included on the outside of the induction coil 181 in order to increase the efficiency of induction heating. An induction heating heater may include a susceptor, and may generate heat based on a magnetic field generated by the induction coil 181. According to an embodiment, the induction heating heater (e.g., a susceptor) (or a heater module including the induction heating heater) may be arranged to be detachable from the housing 10.

According to an embodiment, the heater 181 may be multiple heaters. The multiple heaters may include a first heater and a second heater, and may be inserted into the aerosol generating article 2. The first heater and the second heater may be arranged in parallel to each other in a longitudinal direction. The first heater and the second heater may operate as electrically resistive heaters and/or induction heating heaters, and may be sequentially heated or may be simultaneously heated. In this case, the first heater and the second heater may be respectively arranged at locations corresponding to longitudinal locations of two or more aerosol generating rods. Alternatively, the first heater and the second heater may be respectively arranged at locations corresponding to longitudinal locations of a first portion and a second portion of one aerosol generating rod. When the heater 182 is an induction heating heater, the aerosol generating device 1 may include a first induction coil and a second induction coil, and the first induction coil and the second induction coil may be respectively arranged at locations corresponding to longitudinal locations of the first heater and the second heater. Alternatively, the first heater and the second heater may be respectively arranged at locations corresponding to longitudinal locations of a first portion and a second portion of the one heater 182. Three or more heaters and/or three or more induction coils may be included.

According to an embodiment, a susceptor may be disposed (or included) in the inside (e.g., the medium portion) of the aerosol generating article 2, and the susceptor included within the aerosol generating article 2 may be implemented to generate heat, based on the magnetic field generated by the induction coil 181.

Referring to FIG. 3, the heater 183 may be an external heating heater.

According to an embodiment, the external heating heater may extend long upward around a space (i.e., the insertion space) into which the aerosol generating article 2 is inserted. For example, the external heating heater may be disposed to surround at least a portion of the insertion space. For example, the external heating heater may include a tubular shape (e.g., a cylindrical shape) including a hollow therein. The external heating heater may have a shape including a hollow on the inside and surrounding the hollow. In this case, the external heating heater may be supported by a polyimide film. A heater supported by such a film may be referred to as a film heater. The external heating heater may be disposed to surround at least a portion of the insertion space. The external heating heater may heat the outside of the aerosol generating article 2 inserted into the hollow.

According to an embodiment, the external heating heater may include an electrically resistive heater and/or an induction heating heater. A description of FIG. 3 that overlaps with FIG. 2 will be omitted. In the case of induction heating heaters, the aerosol generating device 1 may include an external heating heater implemented as a tube-shaped susceptor, and may include the induction coil 181 surrounding at least a portion of the external heating heater (e.g., being positioned outside to correspond to a length of at least a portion of the heater). The induction coil 181 may include a fan coil. When the external heating heater is an electrically resistive heater, heat generation is possible through a current flow on a tube-shaped electrically resistive heater (e.g., a film heater), and thus the separate induction coil 181 may be omitted. Insulation may also be disposed on the outside of the external heating heater. Accordingly, the heat radiated outward by the heater 183 and applied to the outside of the housing 10 may be reduced.

According to one embodiment, the heater 183 may be multiple heaters, and the first heater and the second heater may be arranged side by side along the longitudinal direction so as to each surround at least a portion of the insertion space. The first heater and the second heater may operate as electrically resistive heaters and/or induction heating heaters, and may be sequentially heated or may be simultaneously heated. When the heater 183 is an induction heating heater, the aerosol generating device 1 may include a first induction coil and a second induction coil, and the first induction coil and the second induction coil may be respectively arranged at locations corresponding to longitudinal locations of the first heater and the second heater. Alternatively, the first heater and the second heater may be respectively arranged at locations corresponding to longitudinal locations of a first portion and a second portion of the one heater 183.

Unlike what is shown in FIG. 2 or FIG. 3, the heater 182 of FIG. 2 and the heater 183 of FIG. 3 may be included together in the aerosol generating device 1. In this case, the heater 182 may heat the inside of the aerosol generating article 2, and the heater 183 may heat the outside of the aerosol generating article 2.

According to an embodiment, the aerosol generating device 1 may be provided with an airflow channel through which air flows. For example, the housing 10 may include a structure (e.g., a hole) in which air may be introduced from the outside into the housing 10. The air introduced into the housing 10 may be introduced into the aerosol generating article 2 through the lower end (i.e., an upstream side) of the aerosol generating article 2. Aerosol generated based on the heating of the aerosol generating article 2, together with the introduced air, may be inhaled into the user's mouth through the upper end (i.e., the downstream side) of the aerosol generating article 2.

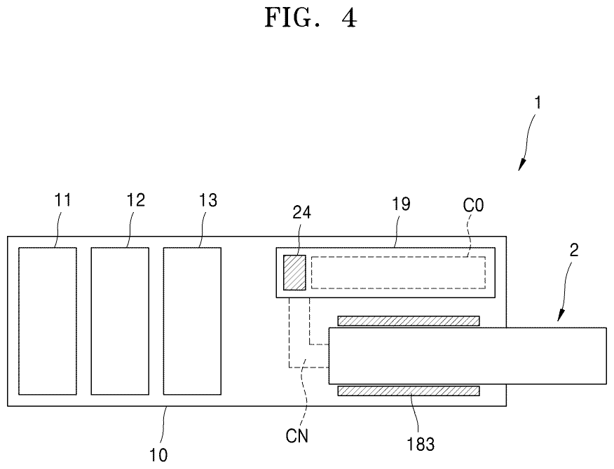

FIG. 4 illustrates an aerosol generating device according to an embodiment.

According to an embodiment, the aerosol generating device 1 may include the housing 10, the power supply 11, the controller 12, the sensor unit 13, and/or the heaters 183 and 24 (e.g., the heater 18 or 24 of FIG. 1). However, the components included in the aerosol generating device 1 are not limited to those shown in FIG. 4. It may be understood by those skilled in the art that some of the components shown in FIG. 4 may be omitted or new components may be added. In the drawings below, any description that overlaps with FIG. 1 will be omitted.

According to an embodiment, the housing 10 may provide a space (hereinafter, an insertion space) opened upward so that the aerosol generating article 2 may be inserted. The insertion space may be recessed toward the inside of the body 10 by a certain depth so that at least a portion of the aerosol generating article 2 may be inserted thereinto. The lower end of the aerosol generating article 2 may be inserted into the housing 10, and the upper end of the aerosol generating article 2 may protrude to the outside of the housing 10.

Unlike the illustration, the cartridge 19 may provide an insertion space for accommodating the aerosol generating article 2. In this case, the insertion space may be recessed toward the inside of the cartridge 19 by a certain depth so that at least a portion of the aerosol generating article 2 may be inserted thereinto. The lower end of the aerosol generating article 2 may be inserted into the cartridge 19, and the upper end of the aerosol generating article 2 may protrude to the outside of the cartridge 19. In this case, the aerosol generating device 1 may not include the heater 183.

According to an embodiment, the depth of the insertion space may be equal to or greater than a length of a region in the aerosol generating article 2, in which an aerosol generating material and/or a medium is included. A user may inhale aerosol by holding, in his or her mouth, the upper end of the aerosol generating article 2 exposed to the outside.

According to an embodiment, the heater 183 may heat the aerosol generating article 2. The heater 183 may extend long upward around the space (i.e., the insertion space) into which the aerosol generating article 2 is inserted. For example, the heater 183 may have a tubular shape (e.g., a cylindrical shape) including a hollow therein. The heater 183 may have a shape including a hollow on the inside and surrounding the hollow. In this case, the heater 183 may be supported by a polyimide film. A heater supported by such a film may be referred to as a film heater. The heater 183 may be arranged to surround at least a portion of the insertion space. The heater 183 may heat the outside of the aerosol generating article 2 inserted into the hollow. In the disclosure, the heater 183 may be referred to as an external heating heater that heats the outside of the aerosol generating article 2. Insulation may also be disposed on the outside of the heater 183. Accordingly, the heat radiated outward by the heater 183 and applied to the outside of the housing 10 may be reduced.

According to an embodiment, the heater 183 may include an electrically resistive heater and/or an induction heating heater.

For example, the electrically resistive heater may include an electrically resistive material, and may be heated as a current flows through the electrically resistive material. In this case, the electrically resistive heater may be electrically connected to the power supply 11, and may generate heat directly by receiving a current from the power supply 11.

For example, in the case of induction heating heaters, the aerosol generating device 1 may include an induction coil (not shown) surrounding at least a portion of the heater 183 (e.g., being disposed outside to correspond to a length of at least a portion of the heater 183). In this case, a magnetic flux concentrator, etc. may be further included on the outside of the induction coil (not shown) in order to increase the efficiency of induction heating. An induction heating heater may include a susceptor, and may generate heat based on a magnetic field generated by the induction coil (not shown).

According to an embodiment, the heater 183 may be multiple heaters. The multiple heaters may include a first heater and a second heater, and may be inserted into the aerosol generating article 2. The first heater and the second heater may be arranged in parallel to each other in a longitudinal direction. The first heater and the second heater may operate as electrically resistive heaters and/or induction heating heaters, and may be sequentially heated or may be simultaneously heated. In this case, the first heater and the second heater may be respectively arranged at locations corresponding to longitudinal locations of two or more aerosol generating rods. Alternatively, the first heater and the second heater may be respectively arranged at locations corresponding to longitudinal locations of a first portion and a second portion of one aerosol generating rod. When the heater 183 is an induction heating heater, the aerosol generating device 1 may include a first induction coil and a second induction coil, and the first induction coil and the second induction coil may be respectively arranged at locations corresponding to longitudinal locations of the first heater and the second heater. Alternatively, the first heater and the second heater may be respectively arranged at locations corresponding to longitudinal locations of a first portion and a second portion of the one heater 183. Three or more heaters and/or three or more induction coils may be included.

Unlike the illustration, the aerosol generating device 1 may not include the heater 183. The aerosol generating article 2 may be heated directly or indirectly by the cartridge heater 24, or may not be substantially heated. The indirect heating may mean that the aerosol generating article 2 is heated by receiving heat contained in the aerosol, while the aerosol generated by the cartridge heater 24 is passing through the aerosol generating article 2. In this case, the aerosol generating device 1 may be referred to as a non-heating (or indirect heating) aerosol generating device. The aerosol generating rod of the aerosol generating article 2 may contain additives such as an alkaline substance. Based on the basic material, nicotine included in the aerosol generating rod may have an alkaline pH (e.g., pH 7.0 or higher). This alkaline nicotine may flow into the user's mouth, together with the aerosol flowing from the cartridge 19, which will be described later, into the aerosol generating article 2.

Unlike the illustration, the heater 183 may include an internal heating heater. For example, the internal heating heater may include any of various heating elements, such as a rod-shaped heating element, a tube-shaped heating element, a plate-shaped heating element, or a needle-shaped heating element. The internal heating heater may be inserted through a lower side of the aerosol generating article 2, and may be set to heat the inside of the aerosol generating article 2.

According to an embodiment, the cartridge 19 may be detachably coupled to the housing 10. For example, a space may be formed on one side of the housing 10, and at least a portion of the cartridge 19 may be inserted into the space formed on one side of the body 10, so that the cartridge 19 may be mounted in the housing 10. Alternatively, the cartridge 19 may be integrally formed with the housing 10.

According to an embodiment, the aerosol generating device 1 and/or the cartridge 19 may be provided with an airflow channel through which air flows. For example, the housing 10 may include a structure in which air may be introduced from the outside into the housing 10 while the cartridge 19 is being inserted into the housing 10. The introduced air may pass through the cartridge 19 and be introduced into the insertion space through an airflow channel CN, and may flow into the user's mouth. The airflow channel CN may include various structures for reducing residual droplets or facilitate airflow.

In FIG. 4, the cartridge 19 is shown as being positioned on a lateral side with respect to the aerosol generating article 2, and the airflow channel CN is shown as being formed from a lateral surface of the aerosol generating article 2 to the lower end (i.e., the upstream side) of the aerosol generating article 2. However, the locations of the cartridge 19 and the airflow channel CN are not limited thereto. For example, the cartridge 19 may be located adjacent to the lower end (i.e., the upstream side) of the aerosol generating article 2. In this case, the airflow channel CN may be formed in a substantially straight shape to connect the cartridge 19 to the lower end (i.e., the upstream side) of the aerosol generating article 2.

According to an embodiment, the cartridge 19 may include a storage CO containing an aerosol generating material, the cartridge heater 24, and/or a liquid delivery unit impregnated with (containing) the aerosol generating material. The liquid delivery unit may be impregnated with the aerosol generating material supplied by the storage CO. For example, the liquid delivery unit may include a wick or the like, such as a cotton fiber, a ceramic fiber, a glass fiber, or porous ceramic.

According to an embodiment, the cartridge heater 24 may heat the aerosol generating material included in the cartridge 19. For example, the cartridge heater 24 may include an electrically resistive heater and/or an induction heating heater.

For example, the electrically resistive heater may include an electrically resistive material, and may generate heat as a current flows through the electrically resistive material. As another example, in the case of induction heating heaters, the aerosol generating device 1 may further include an induction coil (not shown) around the induction heating heater. The induction heating heater may include a susceptor, and may generate heat based on a magnetic field generated by the induction coil (not shown). The cartridge heater 24 may be formed in the shape of a coil that surrounds (or is wound around) the liquid delivery unit and/or in a shape (e.g., a pattern shape) in contact with one side of the liquid delivery unit.

Unlike the illustration, the cartridge heater 24 may be included in the aerosol generating device 1. For example, the cartridge heater 24 may be included inside the housing 10. In this case, the cartridge 19 and the cartridge heater 24 may be separated from each other by removing the cartridge 19.

According to an embodiment, aerosol may be generated based on the heat generation of the cartridge heater 24. For example, as the aerosol generating material impregnated in the liquid delivery unit is heated by the cartridge heater 24, vapor may be generated from the aerosol generating material, and, as the generated vapor is mixed with outside air introduced into the cartridge 19, aerosol may be generated. The aerosol generated by the cartridge heater 24 may be introduced into the aerosol generating article 2 through the airflow channel CN. Tobacco or a flavoring agent may be added to the aerosol while the aerosol is passing through the aerosol generating article 2, and the aerosol to which tobacco or a flavoring agent has been added may be inhaled into the user's mouth through one end of the aerosol generating article 2.

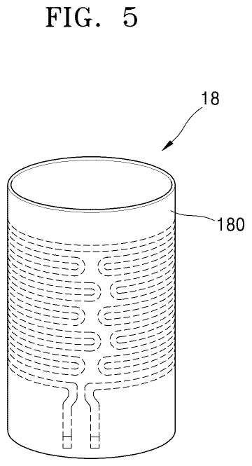

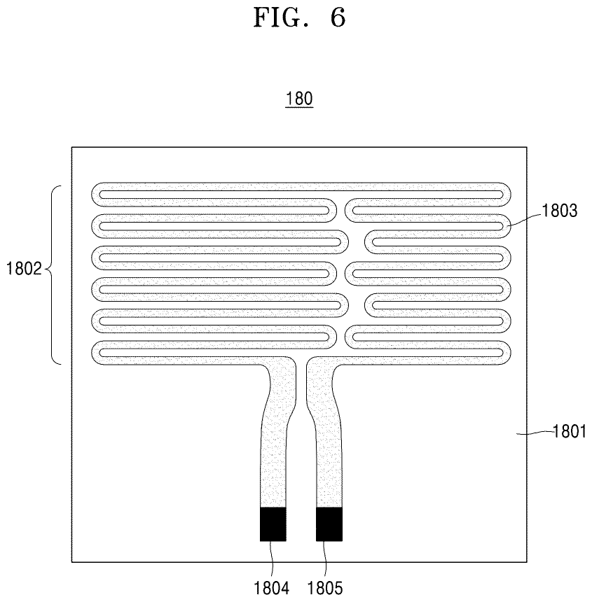

FIG. 5 is a view illustrating a heater implemented in the form of an external heater that heats the outside of an aerosol generating article. FIG. 6 is a view illustrating a heating sheet according to an embodiment.

A heater 18 may be made based on a heating sheet 180 having a flat structure for making an internal heater or an external heater. For example, the heater 183 of FIG. 3 or 4 may be made to heat the outside of the aerosol generating article 2 by rolling the heating sheet 180 of FIG. 6 into a hollow cylindrical or tubular shape to accommodate the aerosol generating article 2 in an internal space of the hollow cylindrical or tubular shape. The heater 18 implemented in the form of an external heater may be made by using at least one heating sheet 180.

The heater 18 may include the heating sheet 180 formed of an electrically resistive material. For example, the heater 18 may include the heating sheet 180 having a flat structure including an electrically resistive plane heating element 1802 in which an electrically conductive track is formed. The heating sheet 180 of the heater 18 may be heated by receiving power from the power supply 11 (see FIGS. 1 to 4) such that a current flows through the electrically resistive plane heating element 1802.

For example, for stable use of the heater 18, power according to the regulations of 3.2 V, 2.4 A, and 8 W may be supplied to the plane heating element 1802 of the heating sheet 180 but is not limited thereto. For example, when power is supplied to the heating sheet 180 of the heater 18, the surface temperature of the heater 18 may increase to 400° C. or more. The surface temperature of the heater 18 may increase to approximately 350° C. before 15 seconds elapses from when power starts to be supplied to the heater 18. However, a range of temperature that may increase may be varied.

Referring to the flat structure of the heating sheet 180 of the heater 18, the heating sheet 180 may include a flexible substrate 1801 formed of an insulating material (an electrical insulating material or thermal insulating material), and the plane heating element 1802 formed on one surface of the flexible substrate 1801 and heated by the power supplied from the power supply 11 to generate an aerosol.

The flexible substrate 1801 may correspond to a green sheet formed of a ceramic composite material. Alternatively, the flexible substrate 1801 may be formed of paper, glass, ceramic, an anodized metal, a coated metal, or polyimide. That is, the flexible substrate 1801 may be an insulating substrate that is formed of various suitable materials and has flexible properties.

The plane heating element 1802 may be connected in series between the first electrode 1804 and the second electrode 1805 and include an electrically conductive track pattern 1803 formed along a zigzag-shaped path. Like the flexible substrate 1801, the plane heating element 1802 may also be flexible.

The electrically conductive track pattern 1803 is formed of an electrically resistive material to determine the heating temperature based on power consumption of a resistor, and a resistance value of the electrically conductive track pattern 1803 may be set based on the power consumption of the resistor of the electrically conductive track pattern 1803.

For example, the resistance value of the electrically conductive track pattern 1803 may range from 0.5 Ω to 2.0Ω, preferably 0.7 Ω to 0.85Ω, at room temperature of 25° C., and a range of the resistance value may change without being limited thereto. The resistance value of the electrically conductive track pattern 1803 may be set in various ways depending on a constituent material, a length, a width, a thickness, or a pattern of an electrically resistive material.

The electrically conductive track pattern 1803 may be formed of tungsten, gold, platinum, silver, copper, nickel, palladium, or a combination thereof. Also, the electrically conductive track pattern 1803 may be doped with a suitable doping material and may include an alloy.

The electrically conductive track pattern 1803 may have internal resistance that increases as a temperature increases, according to resistance temperature coefficient characteristics. For example, the temperature and resistance of the electrically conductive track pattern 1803 may be proportional within a preset temperature range.

Specifically, a resistance-temperature relationship equation may be represented by Equation 1 below:

$$R ( T ) = {R}_{0} \times \{ 1 + α \times ( T - {T}_{0} ) \} \qquad Equation 1$$

Here, R(T) is a resistance value at a temperature T, R₀ is an initial resistance value at a reference temperature T₀, α is a temperature coefficient of resistance (TCR), and T₀ may be 0° C. as a reference temperature.

According to the resistance-temperature relationship equation, electrical resistance R of the electrically conductive track pattern 1803 changes depending on the temperature T, and the initial resistance value R₀ at the reference temperature T₀ is determined not only by a material of the electrically conductive track pattern 1803, but also by a physical shape and structure thereof. For example, as a length of the electrically conductive track pattern 1803 increases, resistance increases, resulting in an increase in the initial resistance value R₀.

In addition, an aerosol generating article may have various lengths, and a manufacturer of an aerosol generating device need to design a length of the heater 18 or the electrically conductive track pattern 1803 of the aerosol generating device to be optimized for the aerosol generating article. Even when materials of the electrically conductive track pattern 1803 are the same as each other, when lengths of the heater 18 or the electrically conductive track pattern 1803 are different from each other, the initial resistance value R₀ may change, and accordingly, a manufacturer needs to calculate the initial resistance value R₀ for each model of aerosol generating devices having different heater lengths. Also, when an aerosol generating device is used for an extended period of time, the initial resistance value R₀ may change as a heater deteriorates.

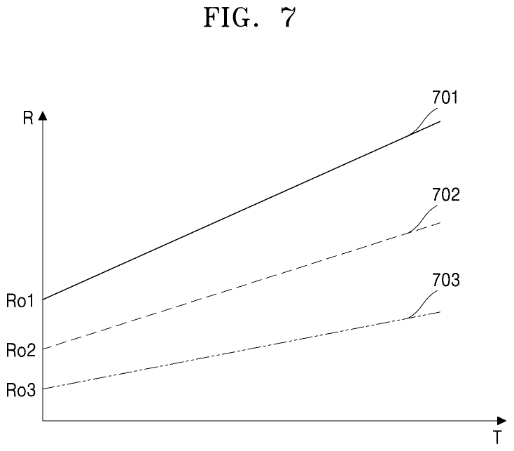

FIG. 7 illustrates graphs of changes in resistance according to a change in temperature.

In FIG. 7, a graph 701 represents an initial resistance value R₀₁, a graph 702 represents an initial resistance value R₀₂, and a graph 703 represents an initial resistance value Ros. As an initial resistance value changes, a slope of a change in resistance according to a change in temperature also changes (see Equation 1). Therefore, it is crucial to accurately calculate the initial resistance value R₀ for precise temperature control of a heater based on a resistance-temperature relationship equation. That is, when the initial resistance value R₀ is not accurately calculated, a temperature estimation value using the resistance-temperature relationship equation may be inaccurate, which may lead to a decrease in heating performance of an aerosol generating device and a poor user experience.

Therefore, it is necessary to provide a method that may more accurately measure the initial resistance value R₀ of a heater even in an environment where resistors having different lengths may be used and compensate for the initial resistance value R₀ when the heater deteriorates.

Referring again to FIGS. 1 to 4, the aerosol generating device 1 according to an embodiment may simply calculate the initial resistance value R₀ of a resistive heater. Also, the aerosol generating device 1 according to an embodiment may determine whether the initial resistance value R₀ changes during use of the aerosol generating device 1, and update the initial resistance value R₀ when the initial resistance value R₀ changes.

The aerosol generating device 1 according to an embodiment may operate in a first operation mode and/or a second operation mode.

A user may operate the aerosol generating device 1 in the first operation mode and/or the second operation mode through the input unit 15. The controller 12 may determine an operation mode of the aerosol generating device 1 in response to a signal received from the input unit 15.

The second operation mode may be a heating operation mode and may include an operation of preheating the heater 18 in a preheating section after the aerosol generating article 2 is inserted into the aerosol generating device 1 and an operation of heating the heater 18 in a smoking section following the preheating section.

The first operation mode may be a test operation mode. The test operation mode of the aerosol generating device 1 may be performed during inspection of products in a process of manufacturing the aerosol generating device 1. During the inspection of products, a product inspector may operate the aerosol generating device 1 in the first operation mode to test the aerosol generating device 1.

The controller 12 may calculate the initial resistance value R₀ of a resistance-temperature relationship equation in the first operation mode. That is, the controller 12 may control the power supplied to the heater 18 such that least power for calculating the initial resistance value R₀ is supplied to the heater 18, in the first operation mode. That is, the controller 12 may control the power supplied to the heater 18 such that first power is supplied to the heater 18 in the first operation mode, and second power greater than the first power is supplied to the heater 18 in the second operation mode.

In another embodiment, the first operation mode may be a cleaning operation mode in which the heater 18 is heated to a higher temperature than the temperature in the second operation mode to vaporize and remove any residual materials remaining in an insertion space. The controller 12 may calculate the initial resistance value R₀ of a resistance-temperature relationship equation in the cleaning operation mode. The controller 12 may heat the heater 18 to a higher temperature than the temperature in the second operation mode to operate the aerosol generating device 1 in the cleaning operation mode. That is, the controller 12 may control the power supplied to the heater 18 such that second power is supplied to the heater 18 in the second operation mode, and the first power greater than the second power is supplied in the first operation mode.

In another embodiment, the controller 12 may also calculate the initial resistance value R₀ of a resistance-temperature relationship equation while supplying a relatively high power to the heater 18 in the second operation mode to remove residual materials remaining in the insertion space.

In addition, because the first operation mode is a test mode for calculating the initial resistance value R₀ and/or a cleaning operation mode for calculating the initial resistance value R₀ and removing residual materials remaining in an insertion space, the first operation mode may be preferably performed in a state where the aerosol generating article 2 has been removed from the insertion space. The controller 12 may cause the aerosol generating device 1 so as not to operate in the first operation mode when a signal corresponding to the first operation mode is transmitted through the input unit 15 in a state where it is determined through the insertion detection sensor that the aerosol generating article 2 has been inserted in the insertion space. That is, the controller 12 may operate the aerosol generating device 1 in the first operation mode only when it is determined that the aerosol generating article 2 has been removed from the insertion space. When the controller 12 determines, through an insertion detection sensor, that the aerosol generating article 2 has been inserted in the insertion space and a signal corresponding to the first operation mode is transmitted through the input unit 15, the controller 12 may provide a user with a notification to remove the aerosol generating article 2 through the output unit 14.

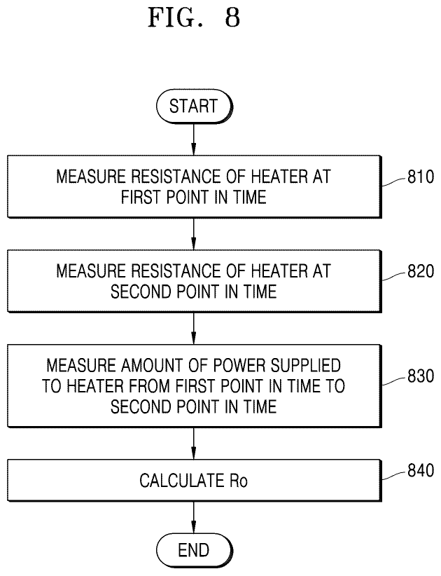

Hereinafter, a method of calculating the initial resistance value R₀ is described in detail with reference to FIG. 8.

FIG. 8 is a flowchart illustrating a method of calculating the initial resistance value R₀, according to an embodiment.

Referring to FIGS. 1 and 8, the controller 12 causes power to be supplied to the heater 18 from a first point in time to a second point in time, and may measure a first resistance value that is a resistance value of the heater 18 at the first point in time, a second resistance value that is a resistance value of the heater 18 at the second point in time, and an amount of power supplied to the heater 18 from the first point in time to the second point in time.

A change in temperature of the heater 18 calculated from the first point in time to the second point in time by using Equation 1 described above may be represented by Equation 2 below.

$$Δ T = {T}_{2} - {T}_{1} = \frac{( {R}_{t 2} - {R}_{t 1} )}{( {R}_{0} \times α )} \qquad Equation 2$$

Here, T1 is the temperature of the heater 18 at the first point in time, and T₂ is the temperature of the heater 18 at the second point in time. In addition, Rₜ₁ is a first resistance value, Rₜ₂ is a second resistance value, R₀ is an initial resistance value at the reference temperature T0, and α is a TCR.

In addition, a temperature change amount AT of the heater 18 from the first point in time to the second point in time is proportional to the time between the first point in time and the second point in time and the energy supplied to the heater 18, and may be represented by Equation 3.

$$c \times m \times Δ T = P \times ( {t}_{2} - {t}_{1} ) \qquad Equation 3$$

Here, c is a specific heat of the heater 18 (more specifically, the electrically conductive track pattern 1803 of FIG. 6) and a unit the heater 18 may be J/kg·° C. m is a mass of the heater 18 (more specifically, the electrically conductive track pattern 1803 of FIG. 6) and a unit of the heater 18 may be kg. P is power supplied to the heater 18 from the first point in time to the second point in time, t₁ is the first point in time, and t₂ is the second point in time.

When Equation 2 and Equation 3 may be represented by Equation 4 below when being rearranged for the initial resistance value R₀.

$${R}_{0} = \frac{c \times m \times ( {R}_{t 2} - {R}_{t 1} )}{P \times ( {t}_{2} - {t}_{1} ) \times α} \qquad Equation 4$$

c representing the specific heat of the heater 18 and m representing the mass of the heater 18 may be calculated in advance by using the data obtained through multiple experiments and stored in a memory, and the controller 12 may calculate the initial resistance value R₀ (operation 840) by measuring the first resistance value Rt that is a resistance value of the heater 18 at the first point in time (operation 810), measuring the second resistance value Rₜ₂ that is a resistance value of the heater 18 at the second point in time (operation 820), and measuring the amount of power P supplied to the heater 18 from the first point in time to the second point in time (operation 830).

In addition, the operations of the flowchart regarding the method of calculating the initial resistance value R₀ illustrated in FIG. 8 do not have to be performed in the illustrated order, and the amount of power P supplied to the heater 18 from the first point in time to the second point in time may be measured, and the second resistance value Rₜ₂, which is the resistance value of the heater 18 at the second point in time, may be measured thereafter or simultaneously.

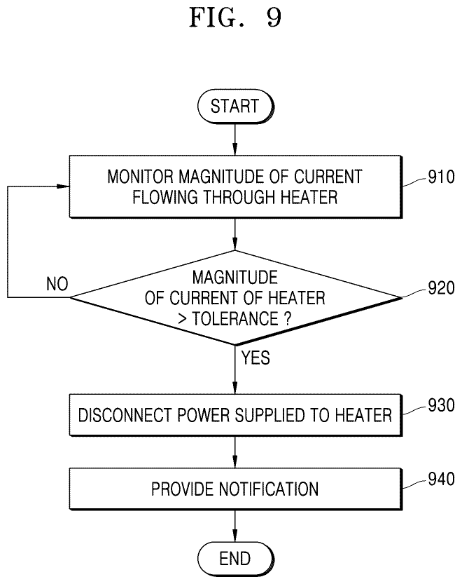

FIG. 9 is a flowchart illustrating a method of monitoring the initial resistance value R₀ in a second operation mode, according to an embodiment.

Referring to FIGS. 1 and 9, the controller 12 may monitor a magnitude of the current flowing through the heater 18 in the second operation mode (operation 910) to determine whether the initial resistance value R₀ is changed due to deterioration of the heater 18 and so on (operation 920). That is, the controller 12 may monitor the initial resistance value R₀ in the second operation mode and determine whether a temperature value of the heater 18, which is estimated based on the initial resistance value R₀, is erroneous.

When it is determined that the initial resistance value R₀ of the heater 18 is changed, the controller 12 may disconnect the power supplied to the heater 18 to stop a heating operation mode of the aerosol generating device 1 (operation 930). When the initial resistance value R₀ is not calculated accurately, a temperature estimation value using a resistance-temperature relationship equation may be inaccurate, which may lead to a decrease in heating performance of the aerosol generating device 1 and a decrease in user experience, and accordingly, it may be desirable to stop the heating operation mode of the aerosol generating device 1.

In addition, when it is determined that the initial resistance value R₀ of the heater 18 is changed, the controller 12 may provide a notification to a user through the output unit 14 such that the aerosol generating device 1 operates in the first operation mode (operation 940). A user may operate the aerosol generating device 1 in the first operation mode through the input unit 15, and the controller 12 may recalculate the initial resistance value R₀ in the first operation mode and update an initial resistance value by using the calculated initial resistance value. After the initial resistance value is updated, the controller 12 may replace a previous initial resistance value R₀_OLD with a newly calculated initial resistance value R₀_NEW in the second operation mode and estimate the temperature of the heater 18 based on the replaced initial resistance value R₀_NEW. A process of calculating the initial resistance value R₀ in the first operation mode is identical to the process described with reference to FIG. 8, and accordingly, detailed descriptions thereof are omitted.

A detailed method by which the controller 12 determines that the initial resistance value R₀ of the heater 18 is changed is as follows. When the magnitude of the current flowing through the heater 18 deviates from a tolerance preset with respect to a magnitude of a current corresponding to the temperature of the heater 18 which is estimated by using a resistance-temperature relationship equation based on the initial resistance value R₀ in the second operation mode, the controller 12 may determine that the initial resistance value R₀ of the heater 18 is changed. The current flowing through the heater 18 is inversely proportional to the resistance of the heater 18, and the resistance of the heater 18 is proportional to the temperature of the heater 18, and accordingly, the current flowing through the heater 18 may be considered to be inversely proportional to the temperature of the heater 18. Correlation data between the current flowing through the heater 18 and the temperature of the heater 18 may be stored in advance in a memory. Alternatively, values related to the temperature of the heater 18 and the current which flows through the heater 18 corresponds to the temperature of the heater 18 may be collected through experiments and stored in advance in a memory in the form of a lookup table. When it is considered by using the data stored in the memory that the magnitude of the current flowing in the heater 18 deviates from the tolerance preset with respect to the magnitude of the current corresponding to the temperature of the heater 18 which is estimated by using the resistance-temperature relationship equation based on the initial resistance value R₀, the controller 12 may determine that the estimation of the temperature of the heater 18 is erroneous, and determine that the initial resistance value R₀, which serves as the basis for the estimation of the temperature of the heater 18, is changed.

A tolerance E may be calculated as a relative error and represented by Equation 5 below.

$$E ( \% ) = \frac{\vert {I}_{m} - {I}_{e} \vert}{{I}_{e}} \times 100 \qquad Equation 5$$

Here, Iₑ is a measured value of the magnitude of the current flowing through the heater 18, and Iₘ is the current corresponding to the estimated temperature of the heater 18 which is a value previously stored in a memory.

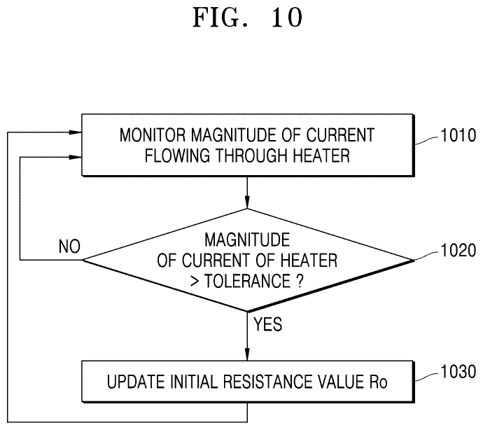

FIG. 10 is a flowchart illustrating a method of updating the initial resistance value R₀ in a second operation mode, according to an embodiment.

The controller 12 may monitor the magnitude of the current flowing through the heater 18 in the second operation mode (operation 1010), determine whether the initial resistance value R₀ is changed due to deterioration of the heater 18 and so on (operation 1020), and when it is determined that the initial resistance value R₀ is changed, the controller 12 may calculate the initial resistance value R₀ and update an initial resistance value by using the calculated initial resistance value (operation 1030). That is, the controller 12 may replace a previous initial resistance value R₀_OLD with a newly calculated initial resistance value R₀_NEW and estimate the temperature of the heater 18 based on the replaced initial resistance value R₀_NEW in the second operation mode.

The controller 12 may calculate the initial resistance value R₀ based on the monitored magnitude of the current flowing through the heater 18 in the second operation mode. Specifically, in the second operation mode, the controller 12 may calculate a first resistance value Rₜ₁ that is a resistance value of the heater 18 at a first point in time, a second resistance value Rₜ₂ that is a resistance value of the heater 18 at a second point in time, and the amount of power P supplied to the heater 18 from the first point in time to the second point in time, based on the monitored magnitude of the current flowing through the heater 18. A process, in which the controller 12 calculates the initial resistance value R₀ through the first resistance value Rt, the second resistance value Rₜ₂, and the amount of power P supplied to the heater 18, is identical to the process described with reference to FIG. 8, and accordingly, detailed descriptions thereof are omitted.

Referring to FIGS. 1 to 10, the aerosol generating device 1 according to an embodiment may include an insertion space into which the aerosol generating article 2 is inserted, the electrically resistive heater 18 arranged adjacent to the insertion space, the power supply 11; and the controller 12 that controls the power supplied from the power supply 11 to the heater 18, wherein the controller 12 may calculate the initial resistance value R₀ of a resistance-temperature relationship equation in a first operation mode and estimate the temperature of the heater 18 based on the resistance-temperature relationship equation in a second operation mode.

The controller 12 calculates the initial resistance value based on a first resistance value of the heater 18 measured at a first point in time, a second resistance value of the heater 18 measured at a second point in time after the first point in time, and an amount of power supplied to the heater 18 from the first point in time to the second point in time, in the first operation mode.

The controller 12 calculates the initial resistance value R₀ based on a value obtained by dividing another value obtained by subtracting the first resistance value from the second resistance value by the amount of power.

The controller 12 monitors a magnitude of a current flowing through the heater 18 in the second operation mode, and when the magnitude of the current flowing through the heater 18 deviates from a tolerance preset with respect to a magnitude of a current corresponding to the estimated temperature of the heater 18, disconnects the power supplied to the heater 18.

The controller 12 controls the power supplied to the heater 18 such that first power is supplied to the heater 18 in the first operation mode and second power greater than the first power is supplied to the heater 18 in the second operation mode.

The controller 12 controls the power supplied to the heater 18 such that second power is supplied to the heater 18 in the second operation mode and first power greater than the second power is supplied to the heater 18 in the first operation mode.

The aerosol generating device 1 further includes an input unit 15 that receives the information input by a user, and the controller 12 determines an operation mode of the aerosol generating device 1 based on a signal received from the input unit 15.

The aerosol generating device 1 further includes an output unit 14 that outputs information on a state of the aerosol generating device 1, and the controller 12 provides a notification to perform the first operation mode through the output unit 14.

The aerosol generating device 1 further includes an output unit that outputs information on a state of the aerosol generating device 1, and an insertion detection sensor that detects insertion and/or removal of the aerosol generating article 2, and when the controller 12 determines through the insertion detection sensor that the aerosol generating article 2 has been inserted in the insertion space and when a signal corresponding to the first operation mode is transmitted through the input unit 15, the controller 12 provides a notification to remove the aerosol generating article 2 through the output unit 14.

The controller 12 operates the aerosol generating device 1 in the first operation mode only when it is determined that the aerosol generating article 2 has been removed.

The aerosol generating device 1 according to an embodiment includes an insertion space into which the aerosol generating article 2 is inserted, an electrically resistive heater 18 arranged adjacent to the insertion space, the power supply 11, and the controller 12 that estimates a temperature of the heater 18 based on a resistance-temperature relationship equation and controls the power supplied to the heater 18 from the power supply 11, wherein the controller 12 monitors a magnitude of a current flowing through the heater 18, and updates an initial resistance value R₀ of the resistance-temperature relationship equation when the magnitude of the current flowing through the heater 18 deviates from a tolerance preset with respect to a magnitude of a current corresponding to the estimated temperature of the heater 18.

The controller 12 updates the initial resistance value R₀ based on a first resistance value of the heater 18 measured at a first point in time, a second resistance value of the heater 18 measured at a second point in time after the first point in time, and the amount of power supplied to the heater 18 from the first point in time to the second point in time.

The controller 12 updates the initial resistance value R₀ based on a value obtained by dividing another value obtained by subtracting the first resistance value from the second resistance value by the amount of power.

The controller 12 controls the power supplied to the heater 18 based on the estimated temperature of the heater 18.

The heater 18 is implemented in the form of an external heater configured to heat the outside of the aerosol generating article 2 inserted in the insertion space.

As described above, the aerosol generating device 1 according to an embodiment may accurately measure the initial resistance value R₀ of the heater 18 and compensate for the initial resistance value R₀ according to deterioration of the heater 18 caused by an operation of the aerosol generating device 1. As a result, the temperature of the heater 18 may be more accurately estimated based on a resistance-temperature relationship equation, and thus, an aerosol may be stably generated. Also, by including a function of updating the initial resistance value R₀ in real time, a temperature estimation error resulting from long-term use may be reduced. As a result, the performance of the aerosol generating device 1 may be maintained over the long term, and a user experience may be improved.

An aerosol generating device according to an embodiment may accurately measure the initial resistance value R₀ of a heater and compensate for the initial resistance value R₀ according to deterioration of the heater caused by an operation of the aerosol generating device.

Any embodiment or other embodiments described above are not exclusive or distinct from each other. Some embodiments or other embodiments described above may be combined or combined with each configuration or function.

For example, it means that the A configuration described in a specific embodiment and/or the drawings and the B configuration described in another embodiment and/or the drawings may be combined with each other. In other words, even if it is not explained directly about combination between the configurations, it is possible to combine unless it is explained that combination is impossible.

The detailed description of the above should not be interpreted in all aspects and should be considered as exemplary. The scope of the disclosure should be determined by a rational interpretation of the attached claims, and all changes within the equivalent scope of the disclosure are included in the scope of the invention.

What is claimed is:

1. An aerosol generating device comprising:
an insertion space into which an aerosol generating article is inserted;
an electrically resistive heater arranged adjacent to the insertion space;
a power supply; and
a controller configured to control power supplied from the power supply to the heater,
wherein the controller is further configured to calculate an initial resistance value of a resistance-temperature relationship equation in a first operation mode and estimate a temperature of the heater based on the resistance-temperature relationship equation in a second operation mode.

2. The aerosol generating device of claim 1, wherein the controller is further configured to, in the first operation mode, calculate the initial resistance value based on a first resistance value of the heater measured at a first point in time, a second resistance value of the heater measured at a second point in time after the first point in time, and an amount of power supplied to the heater from the first point in time to the second point in time.

3. The aerosol generating device of claim 2, wherein the controller is further configured to calculate the initial resistance value based on a value obtained by dividing another value obtained by subtracting the first resistance value from the second resistance value by the amount of power.

4. The aerosol generating device of claim 1, wherein the controller is further configured to, in the second operation mode, monitor a magnitude of a current flowing through the heater, and when the magnitude of the current flowing through the heater deviates from a tolerance preset with respect to a magnitude of a current corresponding to the estimated temperature of the heater, disconnect the power supplied to the heater.

5. The aerosol generating device of claim 1, wherein the controller is further configured to control the power supplied to the heater such that first power is supplied to the heater in the first operation mode and second power greater than the first power is supplied to the heater in the second operation mode.

6. The aerosol generating device of claim 1, wherein the controller is further configured to control the power supplied to the heater such that second power is supplied to the heater in the second operation mode and first power greater than the second power is supplied to the heater in the first operation mode.

7. The aerosol generating device of claim 1, further comprising an input unit configured to receive information input by a user,
wherein the controller is further configured to determine an operation mode of the aerosol generating device based on a signal received from the input unit.

8. The aerosol generating device of claim 4, further comprising an output unit configured to output information on a state of the aerosol generating device,
wherein the controller is further configured to provide a notification to perform the first operation mode, through the output unit.

9. The aerosol generating device of claim 7, further comprising:
an output unit configured to output information on a state of the aerosol generating device; and
an insertion detection sensor configured to detect insertion and/or removal of the aerosol generating article,
wherein, when the controller determines through the insertion detection sensor that the aerosol generating article has been inserted in the insertion space and when a signal corresponding to the first operation mode is transmitted through the input unit, the controller is further configured to provide a notification to remove the aerosol generating article, through the output unit.

10. The aerosol generating device of claim 9, wherein the controller is further configured to operate the aerosol generating device in the first operation mode only when it is determined that the aerosol generating article has been removed.

11. An aerosol generating device comprising:
an insertion space into which an aerosol generating article is inserted;
an electrically resistive heater arranged adjacent to the insertion space;
a power supply; and
a controller configured to estimate a temperature of the heater based on a resistance-temperature relationship equation and control power supplied to the heater from the power supply,
wherein the controller is further configured to monitor a magnitude of a current flowing through the heater, and update an initial resistance value of the resistance-temperature relationship equation when the magnitude of the current flowing through the heater deviates from a tolerance preset with respect to a magnitude of a current corresponding to the estimated temperature of the heater.

12. The aerosol generating device of claim 11, wherein the controller is further configured to update the initial resistance value based on a first resistance value of the heater measured at a first point in time, a second resistance value of the heater measured at a second point in time after the first point in time, and an amount of power supplied to the heater from the first point in time to the second point in time.

13. The aerosol generating device of claim 12, wherein the controller is further configured to update the initial resistance value based on a value obtained by dividing another value obtained by subtracting the first resistance value from the second resistance value by the amount of power.

14. The aerosol generating device of claim 1, wherein the controller is further configured to control the power supplied to the heater based on the estimated temperature of the heater.

15. The aerosol generating device of claim 1, wherein the heater is implemented in a form of an external heater configured to heat an outside of the aerosol generating article inserted in the insertion space.

16. The aerosol generating device of claim 11, wherein the controller is further configured to control the power supplied to the heater based on the estimated temperature of the heater.

17. The aerosol generating device of claim 11, wherein the heater is implemented in a form of an external heater configured to heat an outside of the aerosol generating article inserted in the insertion space.
